(19) United States
(12) Patent Application Publication
(10) Pub. No.: US 2018/0339590 A1
(43) Pub. Date: Nov. 29, 2018

(54) VIRTUAL IMAGE DISPLAY DEVICE, CONTROL METHOD, PROGRAM, AND RECORDING MEDIUM

(71) Applicant: PIONEER CORPORATION, Bunkyo-ku, Tokyo (JP)

(72) Inventor: Tetsuya FUJIE, Kawagoe-shi, Saitama (JP)

(21) Appl. No.: 15/778,990

(22) PCT Filed: Nov. 24, 2015
(86) PCT No.: PCT/JP2015/082851

§ 371 Date: May 24, 2018

(51) Int. Cl. B60K 35/00; G02B 27/01; B60R 1/00

(52) U.S. Cl. CPC B60K 35/00; G02B 27/0101; B60R 1/00; G02B 2027/0138; B60K 2350/2052; B60K 2350/203; B60R 2300/205; B60K 2350/405

(57) ABSTRACT

A display system (100) has a navigation device (1) and a head-up display (2) that displays a virtual image (Iv) using a combiner (8). The combiner (8) is equipped with a reflective member reflecting display light, and is supported so as to be openable and closable. The navigation device (1) performs at least one of the opening control and/or the closing control of the combiner (8), and the navigation device (1) carries out the opening/closing control at the time when a predetermined condition is satisfied. For example, the navigation device (1) automatically closes the combiner (8) to enhance the visibility of a driver in an attention necessary section and in a guidance unnecessary section, or automatically closes the combiner (8) to adhere to highway regulations in an HUD restriction area.

### TECHNICAL FIELD

The present invention relates to a technology of displaying a virtual image over actual scenery.

### BACKGROUND TECHNIQUE

Conventionally, there is a technique of opening/closing a combiner which displays a virtual image by reflection. For example, Patent Reference-1 discloses a display device for a vehicle capable of opening/closing a combiner and adjusting the angle of the combiner by driving a motor.

Patent Reference-1: Japanese Patent Application Laid-open under No. 2005-178725

### DISCLOSURE OF INVENTION

### Problem to be Solved by the Invention

Normally, a combiner for displaying a virtual image is provided between a front window and the eye position of a driver. Thus, in such a case that the concentration on the driving operation by the driver is more important than display by the combiner, the existence of the combiner becomes unnecessary.

The above is an example of the problem to be solved by the present invention. An object of the present invention is to provide a virtual image display device capable of controlling the opening/closing of a reflection unit for displaying a virtual image to keep the eyesight of a driver in a suitable condition.

### Means for Solving the Problem

One invention is a virtual image display device for a moving body, the virtual image display device displaying a virtual image by reflecting a display light emitted from a light source, the virtual image display device including: a reflection unit including a reflective member which reflects the display light, the reflection unit supported to be openable and closable; and an opening/closing control unit configured to perform at least one of an opening control to open the reflection unit and a closing control to close the reflection unit, wherein the opening/closing control unit performs the opening control or the closing control of the reflection unit at a time when a predetermined condition is satisfied.

Another invention is a control method executed by a virtual image display device for a moving body, the virtual image display device displaying a virtual image by reflecting a display light emitted from a light source, the control method including an opening/closing control process to perform at least one of an opening control to open a reflection unit and a closing control to close the reflection unit, the reflection unit supported to be openable and closable, the reflection unit including a reflective member, the reflective member reflecting the display light, wherein the opening/closing control process performs the opening control or the closing control of the reflection unit at a time when a predetermined condition is satisfied.

Still another invention is a program executed by a computer of a virtual image display device, the virtual image display device displaying a virtual image by reflecting a display light emitted from a light source, the program making the computer function as: an opening/closing control unit configured to perform at least one of an opening control to open a reflection unit and a closing control to close the reflection unit, the reflection unit supported to be openable and closable, the reflection unit including a reflective member, the reflective member reflecting the display light, wherein the opening/closing control unit performs the opening control or the closing control of the reflection unit at a time when a predetermined condition is satisfied.

### BRIEF DESCRIPTION OF THE DRAWINGS

FIG. 1 illustrates the schematic configuration of a display system.

FIG. 2 illustrates the schematic configuration of a navigation device.

FIG. 3 illustrates the schematic configuration of a head-up display.

FIG. 4 illustrates an operation of a combiner.

FIG. 5 illustrates the functional configuration of alight source unit.

FIG. 6 is a flowchart indicating an overview of the automatic opening/closing process.

FIG. 7 is a block diagram regarding the determination of the timing of opening/closing the combiner and the opening/closing process.

FIG. 8 illustrates an overview of the calculation process of an opening/closing start point distance.

FIG. 9 is a flowchart indicating the determination of the timing of opening/closing the combiner and the opening/closing process.

### DETAILED DESCRIPTION OF THE PREFERRED EMBODIMENTS

According to a suitable embodiment of the present invention, there is provided a virtual image display device for a moving body, the virtual image display device displaying a virtual image by reflecting a display light emitted from a light source, the virtual image display device including: a reflection unit including a reflective member which reflects the display light, the reflection unit supported to be openable and closable; and an opening/closing control unit configured to perform at least one of an opening control to open the reflection unit and a closing control to close the reflection unit, wherein the opening/closing control unit performs the opening control or the closing control of the reflection unit at a time when a predetermined condition is satisfied.

The above virtual image display device includes a reflection unit and an opening/closing control unit. The reflection unit is equipped with a reflective member which reflects the display light, and supported to be openable and closable. The opening/closing control unit performs at least one of an opening control to open the reflection unit and a closing control to close the reflection unit, and the opening/closing control unit performs the opening control or the closing control of the reflection unit at a time when a predetermined condition is satisfied. According to this mode, the virtual image display device can keep the eyesight of the driver in a preferable condition and/or let the driver adhere to road regulations by opening or closing the reflection unit at the time when a predetermined condition is satisfied.

In one mode of the virtual image display device, the virtual image display device further includes: a present position acquisition unit configured to acquire a present position of the moving body; and a completion point acquisition unit configured to acquire a completion point of the opening control or the closing control of the reflection unit, wherein the opening/closing control unit starts the opening control or the closing control of the reflection unit at a time when the present position of the moving body acquired by the present position acquisition unit reaches a point that is a predetermined distance away from the completion point. According to this mode, the virtual image display device can suitably start to open or close the reflection unit based on a point where the opening control or the closing control of the reflection unit should be completed.

In another mode of the virtual image display device, the virtual image display device further includes: a speed acquisition unit configured to acquire a speed of the moving body; and an opening/closing required time acquisition unit configured to acquire a opening/closing required time that is a time length required to open or close the reflection unit, wherein the opening/closing control unit starts the opening control or the closing control of the reflection unit at a time when the present position of the moving body acquired by the present position acquisition unit reaches a start point of the opening control or the closing control of the reflection unit, the start point acquired based on the speed, the opening/closing required time and the completion point. According to this mode, the virtual image display device can suitably start to open or close the reflection unit so that the opening/closing operation of the reflection unit should be completed at the timing when it reaches the opening/closing completion point of the reflection unit.

In still another mode of the virtual image display device, the reflection unit is provided between a front window of the moving body and a driver in a state where the reflection unit can freely stand and lie down, wherein the completion point acquisition unit acquires, as the complete point of the opening control or the closing control of the reflection unit, a boundary of an area where using the reflection unit is restricted or a point determined based on the boundary. According to this mode, in such an area that the using the reflection unit is restricted, the virtual image display device can let the driver adhere to usage restrictions on the reflection unit by keeping the reflection unit lying down.

In still another mode of the virtual image display device, the virtual image display device further includes a route guide unit configured to provide a guidance on a route of the moving body, wherein the completion point acquisition unit acquires, as the complete point of the opening control or the closing control of the reflection unit, a start point and an end point of such a section of the route that a distance between any neighboring guide points is longer than a predetermined distance. According to this mode, the virtual image display device can keep the eyesight of the driver in a good condition by closing the reflection unit at such a point that any guidance is not needed.

In still another mode of the virtual image display device, the virtual image display device further includes at least one capture unit configured to capture an image in surroundings of the moving body, wherein the opening/closing control unit determines whether or not to open/close the reflection unit based on the image. According to this mode, the virtual image display device recognizes the situation of the running road by analyzing a captured image and precisely determines whether or not to open/close the reflection.

In still another mode of the virtual image display device, the virtual image display device further includes a present position acquisition unit configured to acquire a present position of the moving body; and a start point acquisition unit configured to acquire a start point of the opening control or the closing control of the reflection unit, wherein the opening/closing control unit starts the opening control or the closing control of the reflection unit at a time when the present position of the moving body acquired by the present position acquisition unit reaches the start point. According to this mode, the virtual image display device can precisely determine the timing of starting to open or close the reflection unit.

In still another mode of the virtual image display device, the virtual image display device further includes a boot-up time acquisition unit configured to acquire a boot-up time of the virtual image display device, wherein the opening/closing control unit starts the opening control or the closing control of the reflection unit at a time when the present position of the moving body acquired by the present position acquisition unit reaches a start point of the opening control or the closing control of the reflection unit, the start point specified based on the speed, the opening/closing required time, the completion point and the boot-up time. According to this mode, the virtual image display device can precisely determine the timing of starting to open or close the reflection unit in consideration of the boot-up time of the virtual image display device.

According to another preferable embodiment of the present invention, there is provided a control method executed by a virtual image display device for a moving body, the virtual image display device displaying a virtual image by reflecting a display light emitted from a light source, the control method including an opening/closing control process to perform at least one of an opening control to open a reflection unit and a closing control to close the reflection unit, the reflection unit supported to be openable and closable, the reflection unit including a reflective member, the reflective member reflecting the display light, wherein the opening/closing control process performs the opening control or the closing control of the reflection unit at a time when a predetermined condition is satisfied. By executing the control method, the virtual image display device can keep the eyesight of the driver in a preferable condition and/or let the driver adhere to road regulations by opening or closing the reflection unit at the time when a predetermined condition is satisfied.

According to another preferable embodiment of the present invention, there is provided a program executed by a computer of a virtual image display device, the virtual image display device displaying a virtual image by reflecting a display light emitted from a light source, the program making the computer function as: an opening/closing control unit configured to perform at least one of an opening control to open a reflection unit and a closing control to close the reflection unit, the reflection unit supported to be openable and closable, the reflection unit including a reflective member, the reflective member reflecting the display light, wherein the opening/closing control unit performs the opening control or the closing control of the reflection unit at a time when a predetermined condition is satisfied. By executing the program, the computer can keep the eyesight of the driver in a preferable condition and/or let the driver adhere to road regulations by opening or closing the reflection unit at the time when a predetermined condition is satisfied. In a preferred example, the above program is stored in a recording medium.

### Embodiment

Now, a preferred embodiment of the present invention will be described below with reference to the attached drawings.

[Schematic Configuration]

(1) System Configuration

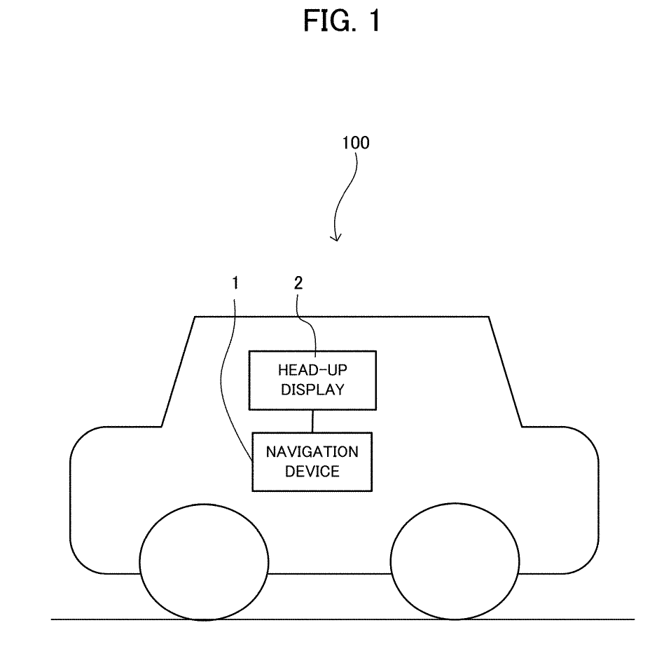

FIG. 1 illustrates an example of the configuration of a display system 100 according to the embodiment. As illustrated in FIG. 1, the display system 100 is mounted on a vehicle and includes a navigation device 1 and a head-up display 2.

The navigation device 1 has a guide function of a route from a departure place to a destination. Examples of the navigation device 1 include a stationary navigation device installed on a vehicle, a PND (Portable Navigation Device) and a cell phone such as a smart phone.

The head-up display 2 generates an image (referred to as “guide image”) indicating guide information for assisting the driving operation and enables the driver to visually recognize the guide image as a virtual image from the position of the eye (eye point) of the driver. The head-up display 2 receives from the navigation device 1 each kind of information needed to generate guide images which indicate information on a guide route and the like.

It is noted that the navigation device 1 may be held by a cradle if the navigation device 1 is a cell phone such as a smart phone. In this case, the navigation device 1 may exchange the information with the head-up display 2 via the cradle. For example, the navigation device 1 and the head-up display 2 constitute the “virtual image display device” according to the present invention.

(2) Configuration of Navigation Device

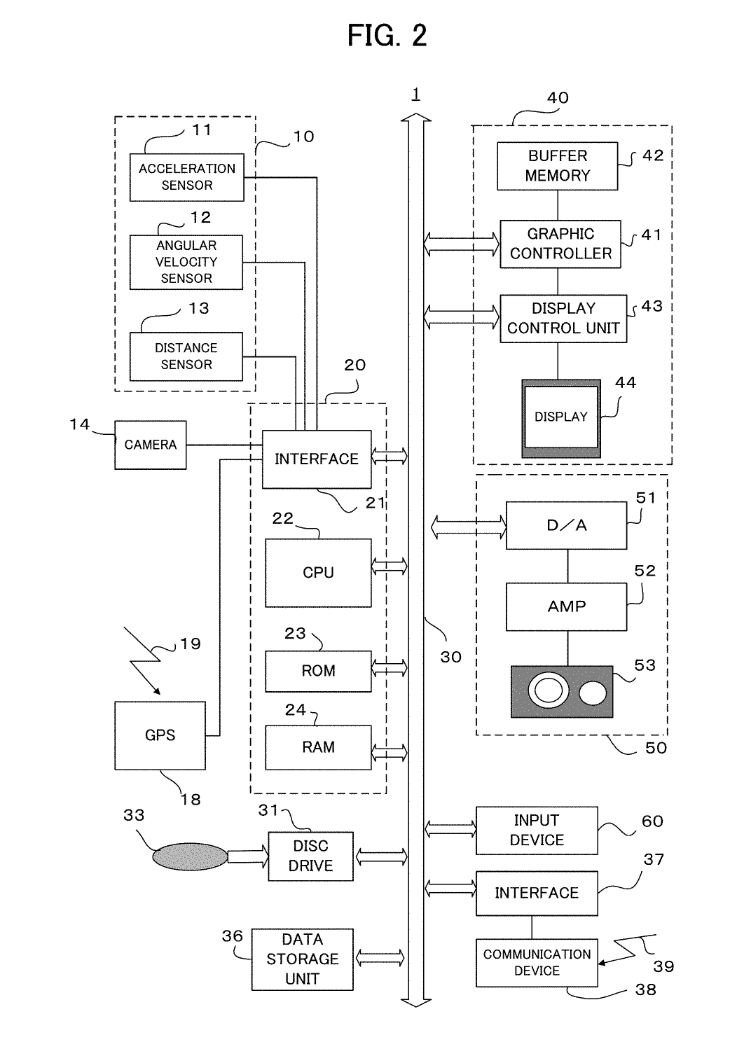

FIG. 2 illustrates a device configuration of the navigation device 1. As shown in FIG. 2, the navigation device 1 includes a stand-alone position measurement device 10, a camera 14, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures a vehicle speed (referred to as “vehicle speed Vo”) by measuring vehicle speed pulses including a pulse signal generated along with the wheel rotation of the vehicle.

The GPS receiver 18 receives an electric wave 19 for transmitting downlink data including position measurement data from plural GPS satellites, which is used for detecting the absolute position (hereinafter referred to as “own vehicle position Lo”) of the vehicle from longitude and latitude information.

The system controller 20 includes an interface 21, a CPU (Center Processing Unit) 22, a ROM (Read Only Memory) 23 and a RAM (Random Access Memory) 24, and is configured to control the entire navigation device 1. For example, according to the embodiment, the system controller 20 searches for a route to a destination which is determined through user input, performs an output control for providing guidance on the determined route, and performs a control of opening and closing a combiner which will be mentioned later. The system controller 20 is an example of the “opening/closing control unit”, the “present position acquisition unit”, the “completion point acquisition unit”, the “speed acquisition unit”, the “opening/closing required time acquisition unit”, the “route guide unit”, the “start point acquisition unit” and a computer which executes a program according to the present invention.

The interface 21 executes the interface operation with the acceleration sensor 11, the angular velocity sensor 12, the distance sensor 13, the camera 14 and the GPS receiver 18. Then, the interface 21 inputs the vehicle speed pulse, the acceleration data, the relative direction data, the angular velocity data, the GPS measurement data, the absolute direction data and the image data into the system controller 20. The CPU 22 controls the entire system controller 20. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 maybe the CD-ROM drive or the DVD-ROM drive, or may be a drive compatible between the CD and the DVD.

The data storage unit 36 includes a HDD, for example, and stores various kinds of data used for a navigation process such as map data. The map data includes road data and facility information on each facility, wherein the road data is expressed by links corresponding to roads and nodes corresponding to connection parts (intersections) of roads.

The communication device 38 includes an FM tuner or a beacon receiver, a mobile phone and a dedicated communication card for example, and receives road traffic information such as traffic jam information and traffic information and other information delivered from a VICS (Vehicle Information Communication System) center via the communication interface 37. The communication device 38 sends the head-up display 2 information needed to display a guide image. Under the control of the system controller 20, the communication device 38 also sends a control signal to a combiner opening/closing motor which will be mentioned later.

The display unit 40 displays various kinds of display data on a display screen of a display 44 under the control of the system controller 20. Concretely, the system controller 20 reads the map data from the data storage unit 36, and the display unit 40 displays, on its display screen, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A (Digital to Analog) conversion of the sound digital data transmitted from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a touch panel which are used for inputting various kinds of commands and data and a sound input device which accepts voice input at the time of a hands-free communication. In the case of stationary navigation device, the input device 60 is arranged in the vicinity of the display 44 and a front panel of a main body of an on-vehicle electric system loaded on the vehicle.

(3) Configuration of Head-Up Display

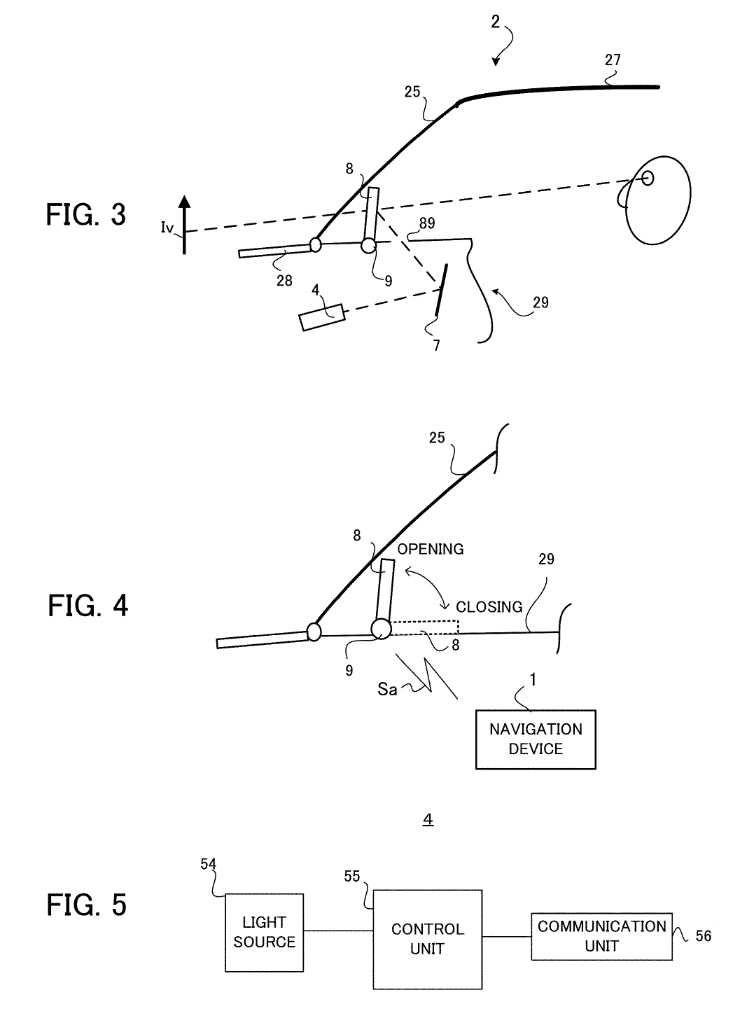

FIG. 3 schematically illustrates configuration of the head-up display 2. As illustrated by FIG. 3, the head-up display 2 according to the embodiments includes a light source unit 4, a screen 7, a combiner 8 and a combiner opening/closing motor 9 and is installed in the vehicle equipped with a front window 25, a ceiling board 27, a hood 28 and a dashboard 29.

The light source unit 4 is provided inside the dashboard 29, and emits light (hereinafter, referred to as “display light”) of a display image towards the screen 7 which is provided inside the dashboard. In this case, the display light reflected by the screen 7 firstly reaches the combiner 8 via an opening 89 made in the dashboard 29, and then reaches the eye point of the driver after further reflection on the combiner 8. In this way, the light source unit 4 enables the driver to visually recognize the virtual image “Iv” by supplying the display light to the eye point of the driver.

The screen 7 is a reflection-type optical element which generates an intermediate image and functions as an EPE (Exit Pupil Expander). For example, on a surface of the screen 7 on which the light from the light source unit 4 is incident, there is formed a microlens array that is plural microlenses arranged, and on the opposite surface of the micrelens array, there is formed a reflection surface.

The combiner 8 is an optical element onto which the light of the intermediate image generated at the screen 7 is projected. The combiner 8 enables an observer to visually recognize the virtual image Iv by reflecting the above projected light towards the eye point of the driver. Preferably, the reflection surface of the combiner 8 which reflects the display image is formed into a substantial concave shape. The combiner 8 therefore enlarges and displays the virtual image Iv. Furthermore, the combiner 8 according to the embodiment is provided on the dashboard 29 in such a state that the combiner 8 can freely stand and lie down. Hereinafter, such a standing state of the combiner 8 that the driver can see the virtual image Iv is referred to as “opening” or “opened state” and such a stored state of the combiner 8 that the combiner 8 is laid down on the dashboard 29 and that the driver cannot see the virtual image Iv is referred to as “closing” or “closed state”. The combiner 8 is an example of the “reflection unit” according to the present invention.

The combiner opening/closing motor 9 adjusts the tilt angle of the combiner 8 based on a control signal “Sa” supplied from the navigation device 1.

FIG. 4 is a drawing for explaining the range of movement of the combiner 8 within which the combiner opening/closing motor 9 can adjust the combiner 8. At the time of receiving, from the navigation device 1, the control signal Sa indicating that the combiner 8 should be switched from the opened state to the closed state, the combiner opening/closing motor 9 tilts the combiner 8 by a predetermined angle (approximately 90 degree in FIG. 4) in clockwise direction so that the combiner 8 moves from the position indicated by the solid line to the position indicated by the dashed line, i.e., so that the upper edge of the combiner 8 moves towards the dashboard 29. In the closed state of the combiner 8, the eyesight of the driver is not interrupted by the combiner 8 since the combiner 8 is not situated on the line connecting the eye point of the driver and the front window 25.

In contrast, at the time of receiving from the navigation device 1 the control signal Sa indicating that the combiner 8 should be switched from the closed state to the opened state, the combiner opening/closing motor 9 tilts the combiner 8 by a predetermined angle (approximately 90 degree in FIG. 4) in anticlockwise direction so that the combiner 8 moves from the position indicated by the dashed line to the position indicated by the solid line, i.e., so that the upper edge of the combiner 8 moves away from the dashboard 29.

FIG. 5 schematically illustrates the configuration of the light source unit 4. As illustrated in FIG. 5, the light source unit 4 includes a light source 54, a control unit 55 and a communication unit 56.

The light source 54 includes laser light sources corresponding to red, blue and green, and projects the display light to display the guide image as the virtual image Iv under the control of the control unit 55.

Under the control of the control unit 55, the communication unit 56 receives various kind of information used for displaying the guide image. For example, the communication unit 56 receives from the navigation device 1 information needed to generate an image to display such as guide route information and present position information.

The control unit 55 includes a CPU, a ROM which stores control programs and data used by the CPU, and a RAM in which various kinds of data are sequentially read out and stored as a working memory, and performs a general control of the head-up display 2. For example, the control unit 55 generates the guide image based on information sent from the navigation device 1 and controls the light source 54 to emit the display light of the generated guide image.

[Automatic Opening/Closing of Combiner]

(1) Overview

Schematically, the system controller 20 firstly specifies a point where opening/closing the combiner 8 should be completed and then determines the timing of starting to open/close the combiner 8 in consideration of the required time (referred to as “opening/closing required time Tc”) taken to switch the combiner 8 from the opened state into the closed state or from the closed state into the opened state.

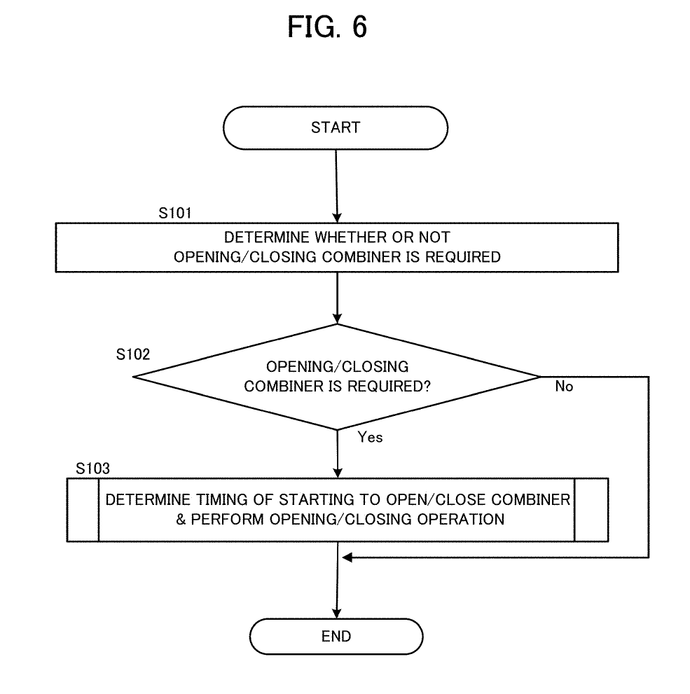

FIG. 6 is a flowchart indicating an overview of the automatic opening/closing process of the combiner 8 executed by the system controller 20 of the navigation device 1. The system controller 20 repeatedly executes the process of the flowchart illustrated in FIG. 6.

First, the system controller 20 determines whether or not opening/closing the combiner 8 is required (step S101). Specifically, the system controller 20 determines whether or not there is such a point (referred to as “opening/closing completion point”) on the guide route to the destination that the combiner 8 should be completely switched from the opened state to the closed state or from the closed state to the opened state. In this case, the system controller 20 may specify the opening/closing completion point on the guide route by referring to map data in which information on opening/closing completion points is recorded or may specify the opening/closing completion point on the guide route by exchanging data with a server device which stores information on opening/closing completion points. Concrete examples of specifying the opening/closing completion point will be described later.

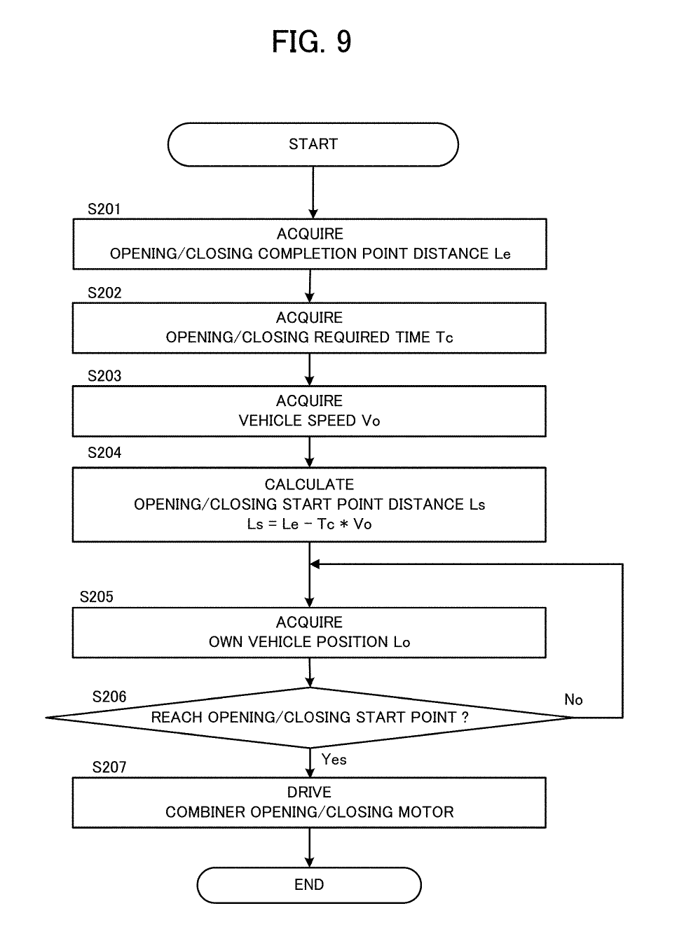

When the system controller 20 determines that opening/closing operation of the combiner 8 is required (step S102; Yes), the system controller 20 determines the timing of starting to open/close the combiner 8 and executes the opening/closing operation as illustrated in FIG. 9 to be mentioned later (step S103). At step S103, in consideration of the opening/closing required time Tc, the system controller 20 determines a point (referred to as “opening/closing start point”) where the opening/closing operation of the combiner 8 should be started so as to complete the state transition by the time the vehicle reaches the opening/closing completion point regarding the combiner 8. Then, the system controller 20 sends the control signal Sa to the combiner opening/closing motor 9 so as to start the opening/closing operation of the combiner 8 at the time of reaching the determined opening/closing start point.

(2) Example of Determining Opening/Closing Completion Point

Next, a description will be given of an example of determining the opening/closing completion point.

(2-1) Determination Based on Restricted Area of HUD

The system controller 20 determines the opening/closing completion point based on a boundary point between an area (referred to as “HUD restricted area”) where there are restrictions (regulations) on the usage of the head-up display 2 and an area (referred to as “HUD unrestricted area”) where there is no restriction on the usage of the head-up display 2. For example, the HUD restricted areas correspond to countries, regions and the like where placing an object (combiner 8 in the embodiment) between the front window 25 and the driver in a state where the object interrupts the eyesight of the driver is prohibited as road rules. In contrast, the HUD unrestricted areas correspond to countries, regions and the like where there is no such road rules.

Then, when entering the HUD restricted area from the HUD unrestricted area, the system controller 20 turns the combiner 8 completely into the closed state by the time the vehicle enters the HUD restricted area at latest. Thus, in this case, the system controller 20 sets the opening/closing completion point to the boundary between the HUD restricted area and the HUD unrestricted area or to such a point in the HUD unrestricted area that is a predetermined distance away from the boundary.

In contrast, when entering the HUD unrestricted area from the HUD restricted area, the system controller 20 operates the combiner 8 so that the combiner 8 is not turned into the opened state until going out from the HUD restricted area at the earliest. Thus, in this case, in consideration of the opening/closing required time Tc, the system controller 20 sets the opening/closing completion point to such a point in the HUD unrestricted area that is a predetermined distance away from the boundary between the HUD restricted area and the HUD unrestricted area. Instead of determining the opening/closing completion point, the system controller 20 may set the opening/closing start point to the boundary between the HUD restricted area and the HUD unrestricted area and start the opening/closing operation of the combiner 8 at the point.

In the above-mentioned determination example of the opening/closing completion point, for example, the navigation device 1 extracts information on the boundary between the HUD restricted area and the HUD unrestricted area from map data stored on the data storage unit 36 or receives the information from a server device. Then, at the time of executing the flowchart in FIG. 6, the system controller 20 determines, at step 5101, whether or not the opening/closing completion point set based on the boundary between the HUD restricted area and the HUD unrestricted area is situated on the guide route to the destination. At the time of determining that the opening/closing completion point set based on the boundary is situated on the guide route, the system controller 20 executes the process at step 5103.

(2-2) Determination Based on Necessity of Guidance

In such a mode (e.g., turn-by-turn navigation mode) that only basic guide information such as traveling direction at a point to turn right or left is displayed, the system controller 20 sets the opening/closing completion point to the entry and the exit of a road section (referred to as “guidance unnecessary section”) where there is poor advantages to display information through the head-up display 2. Namely, at the entry of the guidance unnecessary section, the system controller 20 turns the combiner 8 into the closed state from the opened state and at the exit of the guidance unnecessary section, the system controller 20 turns the combiner 8 into the opened state from the closed state.

Examples of the guidance unnecessary section include a road section that is a single road at least a predetermined distance away from any guide points (which needs guidance, e.g., an intersection), a road section which is within a predetermined distance from the destination of the route guidance, and a road section associated with traveling records indicating that the vehicle has traveled at equal to or more than a predetermined times. In this case, for example, at the time of determining the guide route to the destination, the system controller 20 determines whether or not there is such a guidance unnecessary section on the guide route by referring to the map data and/or information on cumulative traveling records which is stored on the data storage unit 36. Then, at the time of determining that there is a guidance unnecessary section on the guide route, the system controller 20 sets the opening/closing completion point to the entry and the exit of the guidance unnecessary section and executes the process at step S103 in FIG. 6.

(2-3) Determination Based on Reduction of Driver's Distraction

The system controller 20 sets opening/closing completion points to the entry and the exit of a road section (referred to as “attention necessary section”) where a driver's attention is needed and reduction of driver's distraction due to any action other than driving operation should be prioritized. Namely, the system controller 20 turns the combiner 8 into the closed state from the opened state at the entry of the attention necessary section while the system controller 20 turns the combiner 8 into the opened state from the closed state at the exit of the attention necessary section.

The examples of the attention necessary section include a road section situated within a predetermined distance from a school or a school-commuting road, a road section situated within a predetermined distance from a zone estimated to have a lot of pedestrians such as a station, a road section with a narrow width, and a road section whose shape is complicated. Other examples of the attention necessary section include a road section which is crowded with vehicles, bicycles, and/or people, and a road section in an area where the weather is bad (rain or snow). In this case, the system controller 20 determines whether or not there is any attention necessary section on the guide route on the basis of the VICS information which the communication device receives and weather information sent from a server which stores weather information. Then, at the time of determining that there is a attention necessary section on the guide route, the system controller 20 sets opening/closing completion points to the entry and the exit of the attention necessary section and executes the process at step S103 in FIG. 6.

(3) Determination of Timing of Starting to Open/Close Combiner and Opening/Closing Process

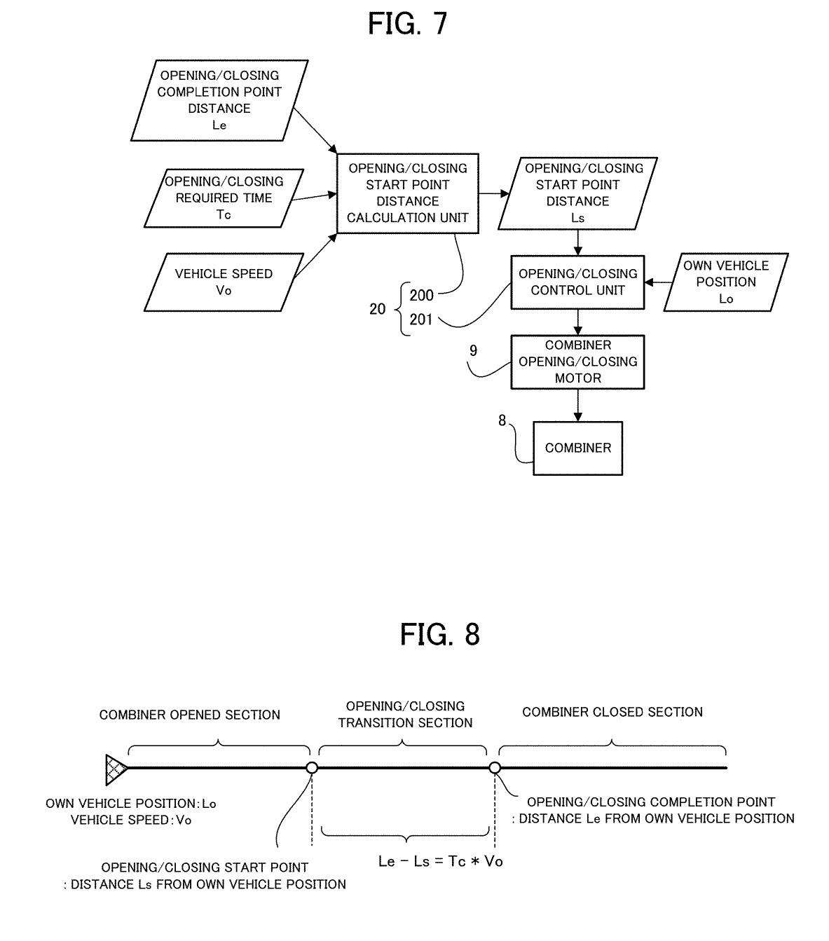

Next, a description will be given of the detail of the process at step S103 in FIG. 6. FIG. 7 is a block diagram which illustrates an overview of the process at step S103. As illustrated in FIG. 7, functionally, the system controller 20 includes an opening/closing start point distance calculation unit 200 and an opening/closing control unit 201. Here, “opening/closing completion point distance Le” indicates the distance from the own vehicle position Lo to the opening/closing completion point at the time of calculation, and “opening/closing start point distance Ls” indicates the distance from the own vehicle position Lo to the opening/closing start point at the time of calculation.

As illustrated in FIG. 7, the opening/closing start point distance calculation unit 200 firstly acquires the opening/closing completion point distance Le and the opening/closing required time Tc and the vehicle speed Vo. In this case, for example, the opening/closing start point distance calculation unit 200 calculates the opening/closing completion point distance Le based on the position information on the opening/closing completion point and information on the own vehicle position Lo outputted by the GPS receiver 18, wherein the opening/closing completion point was specified at the determination at step S101 in FIG. 6 regarding whether or not to open/close the combiner 8. The opening/closing start point distance calculation unit 200 extracts from the data storage unit 36 the opening/closing required time Tc which is measured in advance, while acquiring the vehicle speed Vo from the distance sensor 13.

Next, the opening/closing start point distance calculation unit 200 calculates the opening/closing start point distance Ls based on the opening/closing completion point distance Le, the opening/closing required time Tc and the vehicle speed Vo. Specifically, on the assumption that the vehicle travels at the vehicle speed Vo for the opening/closing required time Tc, the opening/closing start point distance calculation unit 200 calculates the opening/closing start point distance Ls according to the following equation (1).

Ls=Le−Tc·Vo (1)

It is noted that the equation (1) can be applied to both of the case of closing the combiner 8 and the case of opening the combiner 8.

FIG. 8 illustrates an overview of the calculation process of the opening/closing start point distance Ls according to the equation (1) to be executed by the opening/closing start point distance calculation unit 200. FIG. 8 illustrates, as an example, such a case that the combiner 8 has been completely closed at the next opening/closing completion point. In this case, after passing through a combiner opened section, the vehicle runs on an opening/closing transition section and then runs on a combiner closed section, wherein the combiner opened section is a section where the vehicle travels with the combiner 8 completely opened and the opening/closing transition section is a section where the combiner 8 is being turned into the closed state from the opened state and the combiner closed section is a section where the vehicle travels with the combiner 8 completely closed. In this case, on the assumption that the vehicle travels while keeping the vehicle speed Vo at the time of the calculation for the opening/closing required time Tc, the length of the opening/closing transition section is expressed as

Le−Ls=Tc·Vo

Thus, preferably, it is possible to derive the equation (1) from the above equation.

A description will be given of the process executed by the opening/closing control unit 201 with reference to FIG. 7 again. The opening/closing control unit 201 determines whether or not the vehicle reaches the opening/closing start point based on the opening/closing start point distance Ls calculated by the opening/closing start point distance calculation unit 200 and the own vehicle position Lo outputted from the GPS receiver 18. Then, at the time of determining that the vehicle reaches the opening/closing start point, the opening/closing control unit 201 sends the control signal Sa to the combiner opening/closing motor 9 to turn the combiner 8 into the closed state from the opened state or into the opened state from the closed state.

FIG. 9 is a flowchart which indicates a procedure of the process executed at step S103 in FIG. 6.

First, the opening/closing start point distance calculation unit 200 acquires the opening/closing completion point distance Le (step S201). In this case, for example, the opening/closing start point distance calculation unit 200 calculates as the opening/closing completion point distance Le the distance along the guide route between the position of the opening/closing completion point specified at step S101 in FIG. 6 and the own vehicle position Lo outputted from the GPS receiver 18. Next, the opening/closing start point distance calculation unit 200 acquires the opening/closing required time Tc (step S202). For example, the opening/closing start point distance calculation unit 200 acquires the opening/closing required time Tc by extracting, from the data storage unit 36, the opening/closing required time Tc which is measured in advance. Next, the opening/closing start point distance calculation unit 200 acquires the vehicle speed Vo based on the output of the distance sensor 13 and the like (step S203). Then, the opening/closing start point distance calculation unit 200 calculates the opening/closing start point distance Ls according to the equation (1) by using each value acquired at step S201 to step S203 (step S204). In this case, the opening/closing start point is specified as a point on the guide route the distance Ls ahead of the present own vehicle position Lo.

Next, the opening/closing control unit 201 acquires the own vehicle position Lo based on the output of the GPS receiver 18 (step S205). Then, the opening/closing control unit 201 determines whether or not the own vehicle position Lo reaches the opening/closing start point (step S206). In this case, the opening/closing control unit 201 may determine whether or not the latitude and the longitude of the specified opening/closing start point substantially coincide with the latitude and the longitude of the own vehicle position Lo or may determine whether or not the moving distance of the own vehicle position Lo measured from the time of the calculation of the opening/closing start point distance Ls reaches the opening/closing start point distance Ls. Then, at the time of determining that the own vehicle position Lo reaches the opening/closing start point (step S206; Yes), the opening/closing control unit 201 sends the control signal Sa to the combiner opening/closing motor 9 to drive the combiner opening/closing motor 9 to start the opening/closing operation of the combiner 8 (step S207). In contrast, at the time of determining that own vehicle position Lo does not reach the opening/closing start point (step S206; No), the opening/closing control unit 201 keeps monitoring the own vehicle position Lo at step S205.

As described above, the display system 100 according to the embodiment has a navigation device 1 and a head-up display 2 that displays a virtual image Iv using a combiner 8. The combiner 8 is equipped with a reflective member reflecting display light, and is supported so as to be openable and closable. The navigation device 1 performs at least one of the opening control and/or the closing control of the combiner 8, and the navigation device 1 carries out the opening/closing control at the time when a predetermined condition is satisfied. Accordingly, the navigation device 1 can automatically close the combiner 8 to enhance the visibility of a driver in an attention necessary section and in a guidance unnecessary section, or automatically close the combiner 8 to adhere to highway regulation in an HUD restriction area.

[Modifications]

Hereinafter, preferred modifications of the above-mentioned embodiments will be described below. Each modification mentioned later can be applied to the above-mentioned embodiments in combination.

### First Modification

The system controller 20 may determine the timing of starting the opening operation of the combiner 8 by further considering the time (referred to as “HUD boot-up time Tr”) taken for the head-up display 2 to boot up.

In this case, as a precondition, the head-up display 2 is switched to a power-off state, a standby state, or a low power consumption state along with being turned into the closed state and it takes time corresponding to the HUD boot-up time Tr for the head-up display 2 to return from these state to such a state that the head-up display 2 can display the virtual image Iv. In the case of turning the combiner 8 into the opened state from the closed state, the system controller 20 calculates the opening/closing start point distance Ls in consideration of the HUD boot-up time Tr in addition to the opening/closing required time Tc. Specifically, considering that it takes the total time of the opening/closing required time Tc and the HUD boot-up time Tr to switch the combiner 8 from the closed state to such a state that the head-up display 2 can display the virtual image Iv, the system controller 20 calculates the opening/closing start point distance Ls according to the following equation (2).

Ls=Le−(Tc+Tr)·Vo (2)

Thus, at the time of switching the combiner 8 from the closed state to the opened state, the system controller 20 specifies the opening/closing start point distance Ls based on the above-mentioned equation (2). For example, the HUD boot-up time Tr is measured in advance and stored on the data storage unit 36 so that the system controller 20 can read out the HUD boot-up time Tr from the data storage unit 36. It is noted that it is unnecessary to consider the HUD boot-up time Tr in the case of switching the combiner 8 from the opened state to the closed state. Thus, in this case, the system controller 20 specifies the opening/closing start point distance Ls according to the equation (1) in the same way as the embodiment.

It is noted that in such a case that both of the process of switching the combiner 8 from the closed state to the opening state and the process of letting the head-up display 2 return from the power-off state should be executed at the same time, the system controller 20 calculates the opening/closing start point distance Ls by using the longer one out of the opening/closing required time Tc and the HUD boot-up time Tr. In this case, the system controller 20 calculates the opening/closing start point distance Ls according to the following equation (3)

Ls=Le−max{Tc, Tr}·Vo (3)

Even in this case, it is possible to precisely calculate the opening/closing start point distance Ls. It is noted that the system controller 20 according to this modification is an example of the “boot-up time acquisition unit” according the present invention.

### Second Modification

In the display system 100, the head-up display 2 may have functions equivalent to the navigation device 1 instead of the navigation device 1 being provided. In this case, the head-up display 2 includes the stand-alone position measurement device 10 and the GPS receiver 18 and performs the automatic control of opening/closing the combiner 8 by executing the process in the flowchart illustrated in FIG. 6 and FIG. 9 in place of the navigation device 1. The head-up display 2 according to this modification is an example of the “virtual image display device” according to the present invention, and the control unit 55 is an example of the “opening/closing control unit”, the “present position acquisition unit”, the “completion point acquisition unit”, the “speed acquisition unit”, the “opening/closing required time acquisition unit”, the “route guide unit”, the “start point acquisition unit” and the computer which executes a program.

### Third Modification

At step S101 in FIG. 6, the system controller 20 may determines whether or not to open/close the combiner 8 by analyzing an image from the camera 14 which is directed to the front of the vehicle instead of by using the map data.

For example, the system controller 20 extracts a road signage from an image of the camera 14 and recognizes the content of the road signage through a general image recognition method. When the recognized road signage indicates an attention necessary section such as a school zone, the system controller 20 performs a control of closing the combiner 8. In another example, at the time of recognizing a traffic jam and/or a crowd of people from an image of the camera 14, the system controller 20 determines that the running road corresponds to an attention necessary section, and performs a control of closing the combiner 8. In this way, the system controller 20 can preferably determine whether or not to open/close the combiner 8 by analyzing an image of the camera 14.

### Fourth Modification

The navigation device 1 may store information on the opening/closing start point of the combiner 8 on the map data in advance and recognize the opening/closing start point of the combiner 8 by referring to the map data.

In this case, by referring to the own vehicle position Lo, the system controller 20 determines whether or not the vehicle reaches the opening/closing start point registered on the map data. Then, at the time of determining that the vehicle reaches the opening/closing start point, the system controller 20 starts the opening/closing of the combiner 8. In this case, on the map data, there are at least associated position information on each opening/closing start point and information on into which to turn the combiner 8 out of the opening state and the closing state. Even according to this mode, the navigation device 1 can precisely determine the timing of starting to open/close the combiner 8 without using the equation (1).

### Fifth Modification

Instead of determining the opening/closing start point according to the equation (1), the system controller 20 may set the opening/closing start point to a position a predetermined distance before the opening/closing completion point. In this case, the predetermined distance is a fixed value and is preset in consideration of the opening/closing required time Tc and the general upper limit of the moving speed of a vehicle and is stored on the data storage unit 36 in advance. Even according to this mode, the system controller 20 can precisely determine the opening/closing completion point so that the opening/closing operation of the combiner 8 is completed at the opening/closing completion point.

If the opening/closing required time Tc is such a short time that the opening/closing required time Tc can be ignored or the opening/closing completion point is a point unnecessary to be strictly determined (e.g., an entry or an exit of a guidance unnecessary section), the system controller 20 may not treat the opening/closing completion point and the opening/closing start point differently. Namely, in this case, the system controller 20 may start the opening/closing operation of the combiner 8 at the opening/closing completion point which is determined in the embodiment.

### BRIEF DESCRIPTION OF REFERENCE NUMBERS

1 Navigation device

2 Head-up display

4 Light source unit

7 Screen

8 Combiner

25 Front window

28 Hood

29 Dashboard

100 Display system

1. A virtual image display device for a moving body, the virtual image display device displaying a virtual image by reflecting a display light emitted from a light source, the virtual image display device comprising:
a reflection unit including a reflective member which reflects the display light, the reflection unit supported to be openable and closable;
an opening/closing control unit configured to perform at least one of an opening control to open the reflection unit and a closing control to close the reflection unit;
a present position acquisition unit configured to acquire a present position of the moving body; and
a control point acquisition unit configured to acquire a start point or a completion point of the opening control or the closing control of the reflection unit,
wherein the opening/closing control unit starts the opening control or the closing control of the reflection unit at a time when the present position acquired by the present position acquisition unit reaches the start point or at a time when the present position acquired by the present position acquisition unit reaches a point that is a predetermined distance away from the completion point.

2. (canceled)

3. The virtual image display device according to claim 1, further comprising:
a speed acquisition unit configured to acquire a speed of the moving body; and
an opening/closing required time acquisition unit configured to acquire an opening/closing required time that is a time length required to open or close the reflection unit,
wherein the opening/closing control unit starts the opening control or the closing control of the reflection unit at a time when the present position of the moving body acquired by the present position acquisition unit reaches a start point of the opening control or the closing control of the reflection unit, the start point acquired based on the speed, the opening/closing required time and the completion point.

4. The virtual image display device according to claim 1,
wherein the reflection unit is provided between a front window of the moving body and a driver in a state where the reflection unit can freely stand and lie down, and
wherein the control point acquisition unit acquires, as the complete point of the opening control or the closing control of the reflection unit, a boundary of an area where using the reflection unit is restricted or a point determined based on the boundary.

5. The virtual image display device according to claim 1, further comprising
a route guide unit configured to provide a guidance on a route of the moving body, wherein the control point acquisition unit acquires, as the complete point of the opening control or the closing control of the reflection unit, a start point and an end point of such a section of the route that a distance between any neighboring guide points is longer than a predetermined distance.

6. The virtual image display device according to claim 1, further comprising
at least one capture unit configured to capture an image in surroundings of the moving body,
wherein the opening/closing control unit determines whether or not to open/close the reflection unit based on the image.

7. (canceled)

8. The virtual image display device according to claim 3, further comprising
a boot-up time acquisition unit configured to acquire a boot-up time of the virtual image display device,
wherein the opening/closing control unit starts the opening control or the closing control of the reflection unit at a time when the present position of the moving body acquired by the present position acquisition unit reaches a start point of the opening control or the closing control of the reflection unit, the start point specified based on the speed, the opening/closing required time, the completion point and the boot-up time.

9. A control method executed by a virtual image display device for a moving body, the virtual image display device displaying a virtual image by reflecting a display light emitted from a light source, the control method comprising:
performing at least one of an opening control to open a reflection unit and a closing control to close the reflection unit, the reflection unit supported to be openable and closable, the reflection unit including a reflective member, the reflective member reflecting the display light;
acquiring a present position of the moving body; and
acquiring a start point or a completion point of the opening control or the closing control of the reflection unit,
wherein the opening control or the closing control of the reflection unit is performed at a time when the present position acquired by the present position acquisition unit reaches the start point or at a time when the present position acquired by the present position acquisition unit reaches a point that is a predetermined distance away from the completion point.

10. A non-transitory computer readable medium including instructions executed by a computer of a virtual image display device, the virtual image display device displaying a virtual image by reflecting a display light emitted from a light source, the instructions comprising:
performing at least one of an opening control to open a reflection unit and a closing control to close the reflection unit, the reflection unit supported to be openable and closable, the reflection unit including a reflective member, the reflective member reflecting the display light;
acquiring a present position of the moving body; and
acquiring a start point or a completion point of the opening control or the closing control of the reflection unit,
wherein the opening control or the closing control of the reflection unit is performed at a time when the present position acquired by the present position acquisition unit reaches the start point or at a time when the present position acquired by the present position acquisition unit reaches a point that is a predetermined distance away from the completion point.

11. (canceled)

12. The virtual image display device according to claim 1,
wherein, in case of entering a restricted area where using the reflection unit is restricted, the opening/closing control unit completes the closing control by a time when the present position reaches the restricted area.

13. The virtual image display device according to claim 1,
wherein, in case of going out of an area where using the reflection unit is restricted, the opening/closing control unit starts the opening control after the present position goes out of the restricted area.
